(19) United States
(12) Patent Application Publication
(10) Pub. No.: US 2025/0374040 A1
(43) Pub. Date: Dec. 4, 2025

(54) INFORMATION PROCESSING METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventors: Zhengyi SHANG, Beijing (CN); Wei LU, Beijing (CN)

(73) Assignee: BEIJING XIAOMI MOBILE SOFTWARE CO., LTD., Beijing (CN)

(21) Appl. No.: 18/875,285

(22) PCT Filed: Jun. 16, 2022
(86) PCT No.: PCT/CN2022/099286

§ 371 Date: Dec. 16, 2024

(51) Int. Cl. H04W 12/0431; H04W 12/041; H04W 12/106

(52) U.S. Cl. CPC H04W 12/0431; H04W 12/041; H04W 12/106

(57) ABSTRACT

A method for information processing performed by a first UE that is a UE-to-UE relay UE or a remote UE; including: acquiring a credential, wherein the credential comprises a first key (S1110); and carrying out a secure direct communication with a second UE based on the first key (S1120).

### CROSS-REFERENCE TO RELATED APPLICATION

This application is the U.S. national phase application of International Application No. PCT/CN2022/099286, filed on Jun. 16, 2022, the disclosure of which is incorporated herein by reference in its entirety for all purposes.

### TECHNICAL FIELD

The present disclosure relates to, but is not limited to, the field of wireless communication technology, and in particular to an information processing method and apparatus, a communication device and a storage medium.

### BACKGROUND

A proximity based service (ProSe) in 5^{th} generation (5G) mobile communications, which may also be called a short-distance based service, may relay traffic between user equipments (UEs). This means that a source UE, if it is not able to reach a target UE directly, will try to discover a relay UE to realize a communication with the target UE via a traffic relay of the relay UE.

The UE-to-UE relay UE being an untrusted node may be compromised, allowing the security of information between the peer UEs to be compromised. A malicious relay UE, which may establish a unicast link with the source UE as well as a unicast link with the target UE, may conduct a man-in-the-middle (MITM) attack and compromises the security of a service. Therefore, ensuring the security of UE-to-UE relayed communications is an issue that needs to be further addressed as a matter of urgency in the related art.

### SUMMARY

Examples of the present disclosure provide an information processing method and apparatus, a communication device, and a storage medium.

A first aspect of the examples of the present disclosure provides a method for information processing performed by a first user equipment (UE) that is a UE-to-UE (U2U) relay UE or a remote UE, and the method includes: acquiring a credential, wherein the credential includes a first key; and carrying out a secure direct communication with a second UE based on the first key.

A second aspect of the examples of the present disclosure provides a method for information processing performed by a second UE, and the method includes: receiving a direct communication request sent by a first UE, wherein the direct communication request includes a credential identity (ID), the first UE is a peer UE of the second UE, and the first UE is a U2U relay UE or a remote UE; negotiating a session key with the first UE according to an intermediate key corresponding to the credential ID, wherein the intermediate key is generated based on a first key; and generating, based on the session key, a second key for a secure direct communication with the first UE.

A third aspect of the examples of the present disclosure provides a method for information processing performed by a network device, and the method includes: sending a stored credential to a first UE, wherein the first UE includes a relay UE and/or a remote UE, and the relay UE is configured for U2U relay communications, wherein the credential includes a first key, and the first key is configured for a secure direct communication between the first UE and a second UE, and wherein the second UE is a peer UE of the first UE.

According to the technical solutions provided by the examples of the present disclosure, the first UE and the second UE carry out a secure direct communication based on a credential, with advantage of simple key negotiation and the ability to ensure the security of the direct communication. In this way, either the first UE or the second UE acting as the relay UE is a secure UE, which reduces attacks of the malicious relay UE on a source UE and/or a target UE of the remote UEs during a U2U relay communication, thereby improving the security of the U2U relay communication.

It should be understood that the above general description and the following detailed description are only illustrative and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 illustrates a schematic structural diagram of a wireless communication system according to an example.

FIG. 2 illustrates a schematic flowchart of an information processing method according to an example.

FIG. 3A illustrates a schematic flowchart of an information processing method according to an example.

FIG. 3B illustrates a schematic flowchart of an information processing method according to an example.

FIG. 3C illustrates a schematic flowchart of an information processing method according to an example.

FIG. 4 illustrates a schematic flowchart of an information processing method according to an example.

FIG. 5 illustrates a schematic flowchart of an information processing method according to an example.

FIG. 6 illustrates a schematic flowchart of an information processing method according to an example.

FIG. 7 illustrates a schematic block diagram of an information processing apparatus according to an example.

FIG. 8 illustrates a schematic block diagram of an information processing apparatus according to an example.

FIG. 9 illustrates a schematic block diagram of an information processing apparatus according to an example.

FIG. 10 illustrates a schematic structural diagram of a UE according to an example.

FIG. 11 illustrates a schematic structural diagram of a communication device according to an example.

### DETAILED DESCRIPTION OF THE EMBODIMENTS

Embodiments will be described in detail here, and examples of them are illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatus and methods consistent with some aspects of the examples of the present invention.

The terms used in the present disclosure are for the purpose of describing particular examples only, and are not intended to limit the present disclosure. Terms determined by “a,” “said” and “the” in their singular forms in the present disclosure are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred as second information; and similarly, second information may also be referred as first information. Depending on the context, the word “if” as used herein may be interpreted as “when,” “upon,” or “in response to determining”.

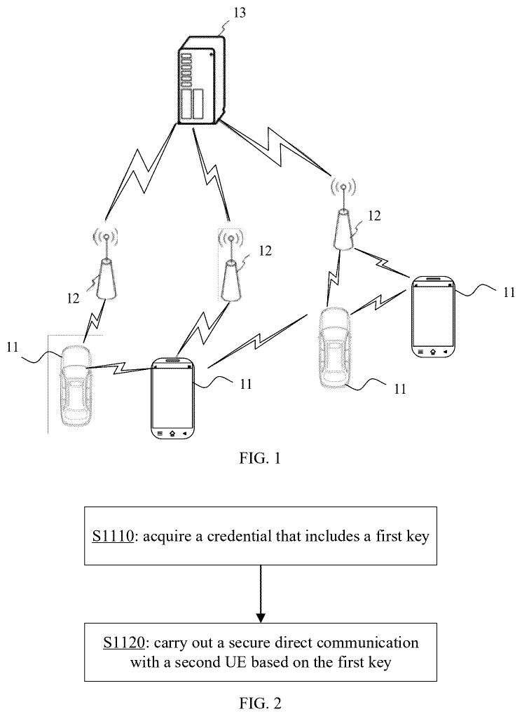

Please refer to FIG. 1, which illustrates a schematic structural diagram of a wireless communication system provided by an example of the present disclosure. As illustrated in FIG. 1, the wireless communication system is a communication system based on cellular mobile communication technologies, and may include several user equipments (UEs) 11 and several access devices 12.

The UE 11 may refer to a device that provides voice and/or data connectivity for a user. The UE 11 may communicate with one or more core networks via a radio access network (RAN). The UE 11 may be an Internet of Things UE, such as a sensor device, a mobile phone (or called a cellular phone), and a computer equipped with the Internet of Things UE, which may be a fixed, portable, pocket-sized, handheld, computer-built-in or vehicle-mounted device as an instance. For example, the UE 11 may be a station (STA), a subscriber unit, a subscriber station, a mobile station, a mobile, a remote station, an access point, a remote UE, an access UE, a user terminal, a user agent, a user device, or a user UE. Or, the UE 11 may be a device like an unmanned drone. Or, the UE 11 may be a vehicle-mounted device, for example, an on-board computer with a wireless communication function or a wireless communication device connected to the on-board computer. Or, the UE 11 may be a roadside device, for example, a street lamp, a signal lamp or any other roadside device with a wireless communication function.

The access device 12 may be a network side device in the wireless communication system. The wireless communication system may be a 4th generation (4G) mobile communication system, which is also known as a long term evolution (LTE) system. Or, the wireless communication system may be a 5th generation (5G) system, which is also known as a new radio (NR) system or a 5G NR system. Or, the wireless communication system may be a next-generation system of the 5G system. The access network in the 5G system can be called a new generation-radio access network (NG-RAN). Or, a machine type communication (MTC) system.

The access device 12 may be an evolved access device (eNB) used in the 4G system. Or, the access device 12 may be an access device (gNB) that adopts a centralized-distributed architecture in the 5G system. When adopting the centralized-distributed architecture, the access device 12 usually includes a central unit (CU) and at least two distributed units (DU). The CU is provided with protocol stacks of a packet data convergence protocol (PDCP) layer, a radio link control (RLC) protocol layer, and a media access control (MAC) layer. The DU is provided with protocol stacks of a physical (PHY) layer. The example of the present disclosure does not limit the specific implementations of the access device 12.

A wireless connection may be established between the access device 12 and the UE 11 via a wireless air interface. In different implementations, the wireless air interface is a wireless air interface based on the 4G mobile communication network technology standards; or, the wireless air interface is a wireless air interface based on the 5G mobile communication network technology standards, for example the wireless air interface is a new air interface; or, the wireless air interface may be a wireless air interface based on the next-generation mobile communication network technology standards of the 5G.

As illustrated in FIG. 2, an example of the present disclosure provides an information processing method, performed by a first UE that is a UE-to-UE (U2U) relay UE or a remote UE, and the method includes the following steps.

S1110, a credential that includes a first key is acquired.

S1120, a secure direct communication is carried out with a second UE based on the first key.

The first UE here may be the U2U relay UE or the remote UE.

For example, the credential may be a long term credential. The long term credential may be a credential that is considered to be valid for a long period of time as long as it is not specifically invalidated. The credential may be issued by a 3A server (an authentication server, an authorization server, and an accounting server) and/or by a communication operator.

The credential includes a credential identifier and/or the first key.

For example, in the example of the present disclosure, UEs supporting the same service type may acquire the same credentials. Thus, based on the first key, a client discovers a second UE supporting the same service type, thereby carrying out a service communication of the same service type based on the secure direct communication.

The second UE here is a peer UE of the first UE. As an example, if the first UE is the relay UE, the second UE is a source UE and/or a target UE of a U2U relay communication. As another example, if the first UE is the remote UE, the second UE may be the relay UE of the U2U relay communication.

In the example of the present disclosure, it carries out a PC5-based U2U direct relay communication with the second UE based on the first key. The PC5 is a direct communication technology.

The secure direct communication here may include a direct communication which is based on a PC5 link and uses a negotiated key.

The direct communication based on the PC5 link here may be a layer-3 (L3) connection.

In view of the above, in the example of the present disclosure, the secure direct communication is carried out based on the credential, with advantage of simple key negotiation and the ability to ensure the security of the direct communication.

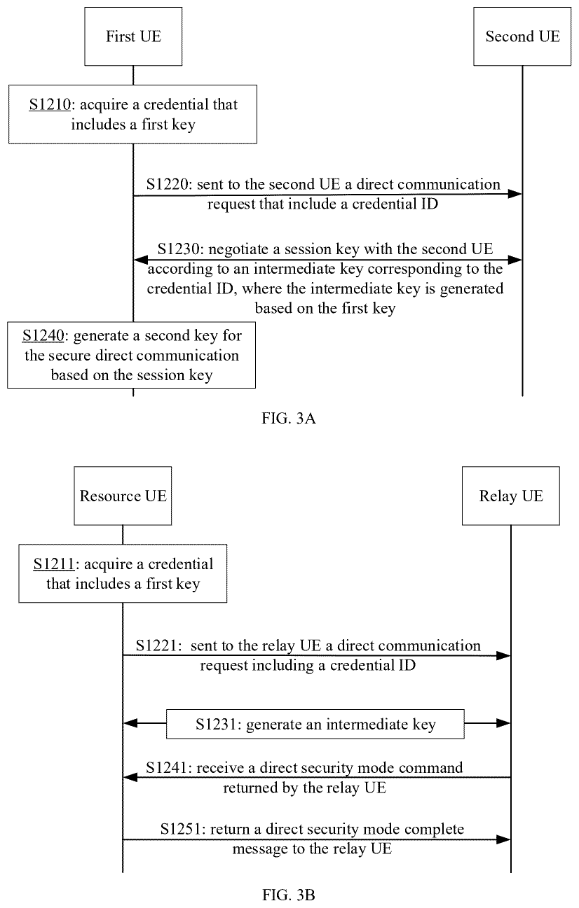

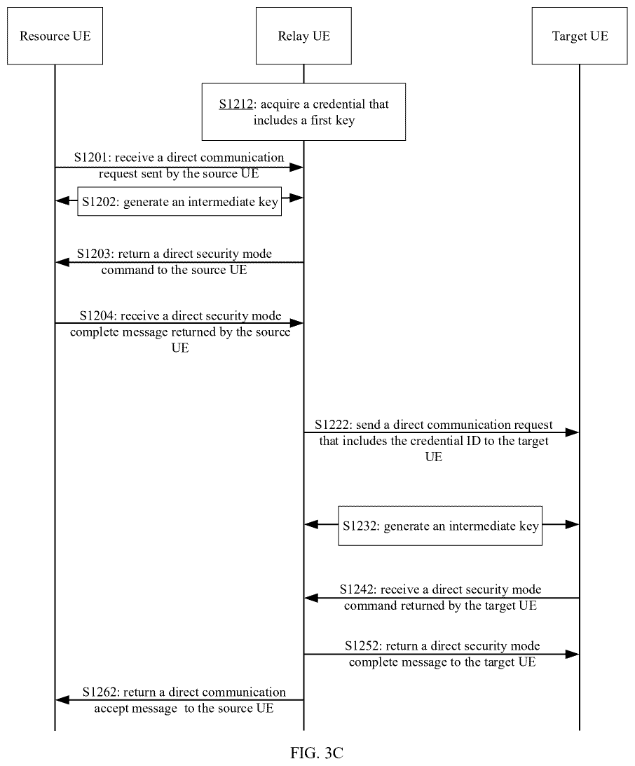

As illustrated in FIG. 3A, an example of the present disclosure provides an information processing method, performed by a first UE that is a U2U relay UE or a remote UE. The method includes the following steps.

S1210, a credential that includes a first key is acquired.

S1220, a direct communication request that include a credential identity (ID) is sent to a second UE.

S1230, it negotiates a session key with the second UE according to an intermediate key corresponding to the credential ID, where the intermediate key is generated based on the first key.

S1240, a second key for the secure direct communication is generated based on the session key.

In some examples, the first UE may send the direct communication request on direct broadcast channels after obtaining the credential. The direct communication request includes the credential ID of the credential.

If another UE receive the direct communication request from the broadcast channel, it may extract the credential ID, and based on the credential ID, it can know which credential's first key is used to generate the session key and know the service type of the current communication between the first UE and the second UE.

In the example of the present disclosure, the first UE may determine the intermediate key independently, or may negotiate the intermediate key with the second UE. For example, in certain specific cases, the first UE may determine the intermediate key according to a historical intermediate key of the secure direct communication between the first UE and the second UE, or may temporarily negotiate the intermediate key.

Thus, the first UE subsequently determines the session key based on the intermediate key. The session key is further configured for determining the second key. The second key may be configured for the secure direct communication. For example, the second key may include a confidentiality protection key and an integrity protection key. The confidentiality protection key is used for an information confidentiality protection of a PC5-based direct communication. The integrity protection key is used for an integrity protection of the PC5-based direct connection communication.

The second key here is further generated based on the session key. For example, the first UE and the second UE may generate the second key based on an algorithm identifier when both parties know the session key.

In some examples, the direct communication request further includes at least one of the following:

security capability information of the first UE, configured for negotiating with the second UE a security algorithm for carrying out the secure direct communication;

relay service code (RSC);

proximity-based service (ProSe) code;

a first random number, configured for generating the session key; or

an intermediate key ID, where the intermediate key is generated based on the first key.

In the example of the present disclosure, the direct communication request may include the security capability information of the first UE. The security capability information may include at least the algorithm identifier of the security algorithm supported by the first UE. In this way, after receiving the direct communication request, the second UE may know the security algorithm supported by the first UE according to the security capability information of the first UE. Combined with a security algorithm supported by itself, the second UE may then select the security algorithm supported by both the first UE and the second UE as the security algorithm used in the current secure direct communication.

The security algorithm may include a confidentiality protection algorithm and/or an integrity protection algorithm.

The RSC indicates a relay service. The ProSe code indicates a proximity-based service.

The RSC and the ProSe code may be carried in the direct communication request in plaintext. Another UE that monitors the PC5 broadcast channel, after detecting the direct communication request, may determine the credential for generating the intermediate key and/or the session key, as well as the service type corresponding to the current direct communication request, according to the credential ID carried in the direct communication request.

As an example, the credential described in the example of the present disclosure may be issued or distributed according to service types. For example, different RSCs indicate different relay services. The credentials for different service types are different. The ProSe codes for different ProSe services are different. The credentials for different ProSe codes may be different.

The first UE and the second UE, if carried out a secure PC5 link direct communication previously, have previously negotiated the intermediate key. In this case, the ID of the intermediate key that is still valid may be carried in the direct communication request to simplify the secure direct communication establishment and improve the rate of the secure direct communication. Therefore, the process of negotiating the intermediate key between the first UE and the second UE may be skipped if the second UE agrees to use the historically negotiated intermediate key as the intermediate key for the current secure direct communication.

The first random number may be any number randomly generated by the first UE using a random algorithm. The first random number may be configured for generating the session key, and thus the first random number is directly carried in the direct communication request. Therefore, after receiving the direct communication request, the second UE may obtain the first random number required by the session key negotiation.

In some examples, determining the intermediate key based on the first key includes:

determining whether it is not a first time that the first UE and the second UE carry out the secure direct communication; and

acquiring the intermediate key that is generated based on the first key in a historical secure direct communication between the first UE and the second UE and is still within a valid period in response to determining that it is not the first time that the first UE and the second UE carry out the secure direct communication.

For example, it is not the first time that the first UE and the second UE carry out the secure PC5-based direct communication. Since it is not the first time, the first UE and the second UE may have stored the intermediate key before. In this case, the first UE, if wishing to use the intermediate key, is to carry the intermediate key ID within the valid period in the direct communication request, so that the current secure direct communication may skip the intermediate key negotiation process.

In some examples, the method further includes:

negotiating the intermediate key based on the first key.

For example, negotiating the intermediate key based on the first key includes:

negotiating the intermediate key based on the first key in response to the first time that the first UE and the second UE carry out the secure direct communication;

or

negotiating the intermediate key based on the first key in response to determining that it is not the first time that the first UE and the second UE carry out the secure direct communication and the intermediate key generated based on the first key in the previous historical secure direct communication is invalid;

or

negotiating the intermediate key based on the first key in response to determining that: it is not the first time that the first UE and the second UE carry out the secure direct communication, the intermediate key generated based on the first key in the previous historical secure direct communication is valid, but the first UE determines to regenerate the intermediate key.

Negotiating the intermediate key based on the first key may include:

sending a third random number to the second UE;

receiving a fourth random number from the second UE;

generating the intermediate key based on the third random number, the fourth random number and the first key.

As an example, a calculated value is obtained by using a key generation function to perform a calculation with the third random number, the fourth random number and the first key as input parameters, and is taken as the generated intermediate key.

In view of the above, if it is not the first time of the secure communication between the first UE and the second UE, the intermediate key that is still in the valid period may be reused. The security of the intermediate key itself is ensured since the intermediate key is still in the valid period, and the intermediate key is reused instead of a renegotiation, which simplifies the process of establishing the secure direct communication connection and shortens the delay.

However, for high-priority services, the previous intermediate key may not be used. Even if the previous intermediate key is still in the valid period, a new intermediate key may be renegotiated based on security considerations to generate the session key according to the newly negotiated intermediate key and generate the second key based on the session key. The second key is a key used directly in the PC5-based direct communication.

In some examples, the method further includes:

receiving a direct security mode command that includes a second random number;

generating the session key according to the first random number and the second random number;

generating the second key based on the session key; and

performing an integrity check on the direct security mode command with the second key; and

sending a direct security mode complete message to the second UE in response to determining that the direct security mode command passes the integrity check.

After the intermediate key is determined, the first UE will receive the direct security mode command from the second UE. The direct security mode command may include a random number provided by the second UE (i.e., the second random number).

In this case, the first UE obtains the first random number and the second random number, and takes the first random number, the second random number and the intermediate key as input parameters of the key generation function to calculate the session key.

For example, in some examples, the second key may include the confidentiality protection key and the integrity protection key. In this case, the first UE generates a confidentiality key included in the second key based on the session key and an confidentiality protection identifier, and the second UE generates an integrity protection key included in the second key based on the session key and an integrity protection identifier.

For example, the direct security mode command further includes algorithm information. The algorithm information may be the security algorithm that is selected by the second UE according to the security capability information of the first UE and is supported by both the first UE and the second UE.

For the sake of communication security, the first UE, after generating the second key, uses the second key to perform the integrity check on the direct security mode command, and sends a direct security mode complete message to the second UE when the direct security mode command passes the integrity check, which indicates that the second key has been generated and the first UE has completed all preparatory operations for establishing its direct communication connection.

For example, if the first UE receives the direct security mode complete message, it also indicates that the second UE has completed all preparatory operations for establishing its direct communication connection.

In some examples, the direct security mode command further includes the algorithm information on the security algorithm. The security algorithm is selected by the second UE according to the security capability information of the first UE.

The algorithm information may include an algorithm ID and/or the algorithm itself.

In some examples, the first UE is the relay UE, and the second UE includes a source UE and a target UE of the secure direct communication. The method further includes:

establishing a secure direct communication between the source UE and the target UE after the relay UE generates the second keys with the source UE and the target UE respectively.

If the first UE is the relay UE, only after the relay UE determines that each of the source UE and the target UE has generated the second key, the relay UE establish the L3 secure direct communication between the source UE and the target UE, thereby ensuring the security of the direct communication.

In some examples, establishing the secure direct communication between the source UE and the target UE after the relay UE generates the second keys with the source UE and the target UE respectively includes:

sending a direct communication accept message to the source UE after determining that each of the source UE and the target UE generates the second key; and

establishing the secure direct communication between the source UE and the target UE after sending the direct communication accept message to the source UE.

After receiving the direct security mode complete message sent by the source UE, the relay UE may consider that the source UE itself has completed the generation of the second key based on the session key. After each of the source UE and the target UE generates the second key, the relay UE may respond to the direct communication request message sent by the source UE, and thus return the direct communication accept message to the source UE, which indicates that the secure PC5-based direct communication may be established between the source UE and the target UE.

In some examples, the method further includes:

requesting the credential from a network device.

The first UE may request the credential from the network device for storing the credential locally. For example, the credential is requested from the network device such as a policy control function (PCF), a direct discovery name management function (DDNMF), a ProSe key management function (PKMF), or a ProSe server.

For requesting the credential, a device identifier of the first UE and/or the RSC of the relay services supported by the first UE and/or the ProSe code of the proximity services may be carried.

The device identifier includes, but is not limited to, a subscription concealed identifier (SUCI) and/or a subscription permanent identifier (SUPI), etc. The RSC and/or the ProSe code may be used by the network device to determine the credential requested by the first UE. Different services correspond to different credentials. In some examples, the credential is pre-positioned in the relay UE.

For example, the credential may be pre-configured in the first UE before shipment. Alternatively, the credential may be pre-sent to the first UE based on an over the air (OTA) technology before the first UE delivered to the user is officially put into use.

Referring to FIG. 3B, an example of the present disclosure provides an information processing method, which is performed by a source UE. The method includes the following steps.

S1211, a credential is acquired. For example, the source UE is pre-configured with the credential, or requests the credential from a network device. The credential includes a first key and a random number required for generating a session key.

S1221, a direct communication request including a credential ID is sent to a relay UE.

S1231, an intermediate key is generated. This step may be a skipped step. For example, assuming that there is a previously negotiated intermediate key between the source UE and the relay UE that is still in a valid period, this step may be skipped. The generation of the intermediate key may include that, the source UE and the relay UE generate a random number individually and inform each other, and each of the source UE and the relay UE combines the random number generated by itself, the random number generated by the peer UE, and the first key contained in the credential corresponding to the credential ID to generate the intermediate key.

S1241, a direct security mode command returned by the relay UE is received. The direct security mode command may include a random number required for generating the session key. After receiving the direct security mode command, the session key is generated according to the random number included in the direct security mode command and a random number generated by the source UE itself and in combination with the intermediate key. Further, a second key is generated based on the session key.

S1251, a direct security mode complete message is returned to the relay UE after the second key is generated.

Referring to FIG. 3C, an example of the present disclosure provides an information processing method, which is performed by a relay UE. The method includes the following steps.

S1212, a credential is acquired. For example, the relay UE is pre-configured with the credential, or requests the credential from a network device. The credential includes a first key and a random number required for generating a session key.

S1201, a direct communication request sent by a source UE is received.

S1202, an intermediate key between the relay UE and the source UE is generated. This step may be a skipped step. For example, assuming that there is a previously negotiated intermediate key between the source UE and the relay UE that is still in a valid period, this step may be skipped. The generation of the intermediate key may include that, the source UE and the relay UE generate a random number individually and inform each other, and each of the source UE and the relay UE combines the random number generated by itself, the random number generated by the peer UE, and the first key contained in the credential corresponding to the credential ID to generate the intermediate key.

S1203, a direct security mode command is returned to the source UE.

S1204, a direct security mode complete message returned by the source UE is received.

S1222, a direct communication request that include the credential ID is sent to a target UE.

S1232, an intermediate key is generated. This step may be a skipped step. For example, assuming that there is a previously negotiated intermediate key between the target UE and the relay UE that is still in a valid period, this step may be skipped. The generation of the intermediate key may include that, the target UE and the relay UE generate a random number individually and inform each other, and each of the target UE and the relay UE combines the random number generated by itself, the random number generated by the peer UE, and the first key contained in the credential corresponding to the credential ID to generate the intermediate key.

S1242, a direct security mode command returned by the target UE is received. The direct security mode command may include a random number required for generating a session key. After receiving the direct security mode command, the session key is generated according to the random number included in the direct security mode command and a random number generated by the target UE itself and in combination with the intermediate key. Further, a second key is generated based on the session key.

S1252, a direct security mode complete message is returned to the target UE after the second key is generated.

S1262, a direct communication accept message is returned to the source UE to realize the establishment of a secure PC5-based direct communication connection between the source UE and the target UE.

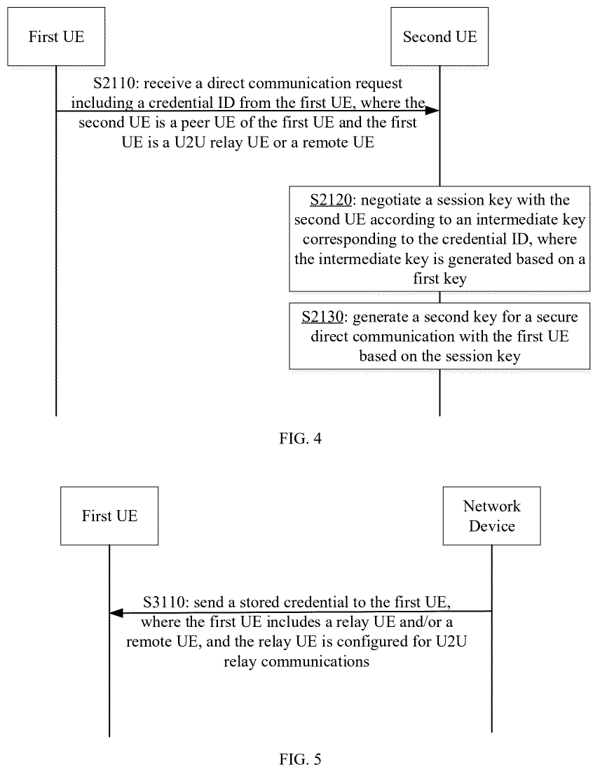

Referring to FIG. 4, an example of the present disclosure provides an information processing method, which is performed by a second UE. The method includes the following steps.

S2110, a direct communication request including a credential ID is received from a first UE, where the first UE is a U2U relay UE or a remote UE.

S2120, it negotiates a session key with the first UE according to an intermediate key corresponding to the credential ID, where the intermediate key is generated based on a first key.

S2130, a second key for a secure direct communication with the first UE is generated based on the session key.

The second UE here is a peer UE of the first UE. For example, if the first UE is the relay UE, the second UE is the remote UE. The remote UE may be a source UE or a target UE. If the first UE is the remote UE, the second UE may be the relay UE.

The second UE monitors broadcast channels of a PC5 link. If a direct communication request is detected, the credential ID may be extracted from the direct communication request. If determining, based on the credential ID, that the second UE has locally stored the credential indicated by the credential ID, the second UE may use the credential ID to determine the service involved in the previous direct communication request with the first UE since the credentials are distributed based on the service types.

The credential stored in the second UE may be a long term credential. The long term credential may be a credential that is considered to be valid for a long period of time as long as it is not specifically invalidated. The credential may be issued by a 3A server and/or by a communication operator.

The credential includes a credential identifier and/or the first key.

For example, in the example of the present disclosure, UEs supporting the same service type may acquire the same credentials. Thus, based on the first key, a client discovers a second UE supporting the same service type, thereby carrying out a service communication of the same service type based on the secure direct communication.

After receiving the direct communication request, the session key is negotiated with the first UE according to the intermediate key generated from the first key included in the credential. The session key may be configured for further generating the second key.

For example, the second key may include a confidentiality protection key and an integrity protection key. The confidentiality protection key is used for an information confidentiality protection of a PC5-based direct communication. The integrity protection key is used for an integrity protection of the PC5-based direct connection communication.

The second key here is further generated based on the session key. For example, when both the first UE and the second UE know the session key, the second key is calculated by taking the session key and an algorithm identifier of a security algorithm as input parameters of a calculation formula.

Based on the second key, the PC5-based U2U direct relay communication is carried out with the first UE.

The secure direct communication here may include a direct communication which is based on a PC5 link and uses the negotiated key.

The direct communication based on the PC5 link here may be an L3 connection.

In view of the above, in the example of the present disclosure, the secure direct communication is carried out based on the credential, with advantage of simple key negotiation and the ability to ensure the security of the direct communication.

In some examples, the direct communication request further includes at least one of the following:

security capability information of the first UE, configured for negotiating with the second UE a security algorithm for carrying out the secure direct communication;

RSC;

ProSe code;

a first random number, configured for generating the session key; or

an intermediate key ID, which is generated based on the first key.

In the example of the present disclosure, the direct communication request may include the security capability information of the first UE. The security capability information may include at least the algorithm identifier of the security algorithm supported by the first UE. In this way, after receiving the direct communication request, the second UE may know the security algorithm supported by the first UE according to the security capability information of the first UE. Combined with a security algorithm supported by itself, the second UE may then select the security algorithm supported by both the first UE and the second UE as the security algorithm used in the current secure direct communication.

The security algorithm may include a confidentiality protection algorithm and/or an integrity protection algorithm.

The RSC indicates a relay service. The ProSe code indicates a proximity-based service.

The RSC and the ProSe code may be carried in the direct communication request in plaintext. Another UE that monitors the PC5 broadcast channels, after detecting the direct communication request, may determine the credential for the current secure direct communication request according to the credential ID carried in the direct communication request and the RSC and/or the ProSe code.

As an example, the credential described in the example of the present disclosure may be issued or distributed according to service types. For example, different RSCs indicates different relay services. The credentials for different service types are different. The ProSe codes for different ProSe services are different. The credentials for different ProSe codes may be different.

The first UE and the second UE, if carried out a secure PC5 link direct communication previously, have previously negotiated the intermediate key. In this case, the intermediate key that is still valid may be carried in the direct communication request to simplify the secure direct communication establishment and improve the rate of the secure direct communication. Therefore, the process of negotiating the intermediate key between the first UE and the second UE may be skipped if the second UE agrees to use the historically negotiated intermediate key as the intermediate key for the current secure direct communication.

The first random number may be any number randomly generated by the first UE using a random algorithm. The first random number may be configured for generating the session key, and thus the first random number is directly carried in the direct communication request. Therefore, after successfully receiving the direct communication request, the second UE may obtain the first random number required by the session key negotiation.

In some examples, the method further includes:

the intermediate key is determined according to the intermediate key ID if the direct communication request includes the intermediate key ID;

or

the intermediate key is generated based on the first key if the direct communication request includes no intermediate key ID.

When the direct communication request includes the intermediate key ID and the intermediate key corresponding to the intermediate key ID is within a valid period, the second UE considers that the process of negotiating the intermediate key with the first UE may be skipped, may directly find the locally stored intermediate key in accordance with the intermediate key ID included in the direct communication request, and determine the intermediate key as the intermediate key for the current secure PC5-based direct communication.

If the direct communication request includes no intermediate key ID, the second UE negotiates the intermediate key with the first UE.

Negotiating the intermediate key with the first UE includes:

receiving a third random number from the first UE;

sending a fourth random number to the first UE;

generating the intermediate key based on the third random number, the fourth random number and the first key.

In view of the above, in the example of the present disclosure, the second UE determine whether it is required to renegotiate the intermediate key with the first UE according to whether the direct communication request received from the first UE includes the intermediate key ID.

In some examples, the method further includes:

sending a direct security mode command that includes a second random number;

generating the session key according to the first random number and the second random number;

generating the second key based on the session key; and

receiving a direct security mode complete message sent by the first UE, where the direct security complete message is sent after the direct security mode command passes an integrity check based on the second key generated by the first UE.

After receiving the direct communication request from the first UE, the second UE sends a direct communication security mode command to the first UE if it responds to the first UE. The direct communication security mode command includes a second random number. The second random number, together with the first random number, is used to generate the session key.

For example, the second UE obtains the first random number and the second random number, and takes the first random number, the second random number and the intermediate key as input parameters of a key generation function to calculate the session key.

The first UE also generates a second key after receiving the direct security mode command from the second UE, and sends a direct connection security mode complete message to the second UE after generating the second key and successfully checking the integrity of the direct security mode command. Therefore, when receiving the direct security mode complete message, the second UE may consider that both the first UE and the second UE have completed the second key generation and can establish the PC5-based direct security communication.

In some examples, the direct security mode command further includes algorithm information on the security algorithm. The security algorithm is selected by the second UE according to the security capability information of the first UE.

The algorithm information includes, but is not limited to, an identifier of the security algorithm.

The security algorithm includes, but is not limited to, a confidentiality protection algorithm and/or an integrity protection algorithm.

If the second UE is the relay UE and the first UE is the source UE or the target UE, the method further includes:

establishing a secure direct communication between the source UE and the target UE after the relay UE generates the second keys with the source UE and the target UE respectively.

For example, establishing the secure direct communication between the source UE and the target UE after the relay UE generates the second keys with the source UE and the target UE respectively includes: sending a direct communication accept message to the source UE after determining that each of the source UE and the target UE generates the second key; and establishing the secure direct communication between the source UE and the target UE after sending the direct communication accept message to the source UE.

In some examples, the method further include that the second UE acquires the credential. The scheme in which the second UE acquires the credential may include that: the second UE requests the credential from a network device, or the second UE pre-stores the credential locally.

As illustrated in FIG. 5, an example of the present disclosure provides an information processing method, which is performed by a network device. The method includes the following steps.

S3110, a stored credential is sent to a first UE, where the first UE includes a relay UE and/or a remote UE, and the relay UE is configured for U2U relay communications.

The credential includes a first key, which is configured for a secure direct communication between the first UE and a second UE. The second UE is a peer UE of the first UE.

The network device may be a DDNMF, a PKMF or a ProSe server, etc. Of course, these are just examples of the network device, whose specific implementation is not limited to these examples. In the example of the present disclosure, the network device may pre-store the credential for a UE, and the UE may subsequently request the credential from the network device. For example, a request message sent by a first UE is received. The request message may include, but is not limited to, RSC and/or ProSe code. The network device may determine the credential requested by the first UE based on the RSC and/or the ProSe code.

The credential may be a long term credential and may be configured for U2U relay communications.

In some examples, the information for the first UE to request the credential may also include an identifier of the UE, which may be used for verifying the UE. After the UE passes the verification, the first UE is considered to be a secure and trustworthy UE, and the credential is sent to the first UE.

For example, the identifier of the UE includes, but is not limited to, an SUCI and/or an SUPI, etc.

A secure L3 U2U link between the source UE and the target UE is established through a U2U relay.

Taking a 5G ProSe service as an example, the 5G ProSe service supports the U2U relay and takes into account both options of L2 UE-to-UE relay and L3 UE-to-UE relay. For the L3 UE-to-UE relay, it has to transform a PC5 packet data convergence protocol (PDCP) message from the source UE into another PC5 PDCP message to be sent to the target UE. Therefore, full security of PC5 one-to-one communication between the source UE and the target UE cannot be established with the presence of the L3 UE-to-UE relay. The indirect communication between the source UE and the target UE via the L3 U2U relay goes through two concatenating PC5 links (between the source UE and the L3 U2U relay UE, and between the L3 U2U relay UE and the target UE). That implies that enforcement of the secure communication between the source UE and the target UE relies on the security protection for each of the concatenating PC5 links.

An example of the present disclosure provides an information processing method, which may include: establishing a secure L3 U2U link between the source UE and the target UE via the UE-to-UE relay, so as to provide integrity and confidentiality of the information transmitted over the UE-to-UE relay, ensure that the remote UE can monitor and identify a malicious attacker acting as the UE-to-UE relay, and ensure that the 5G PKMF can securely provide the security parameters to the remote UE and the U2U relay UE.

It is assumed that the remote UE1, the remote UE2 and the relay UE may all be pre-configured with the same long term credential and long term credential ID.

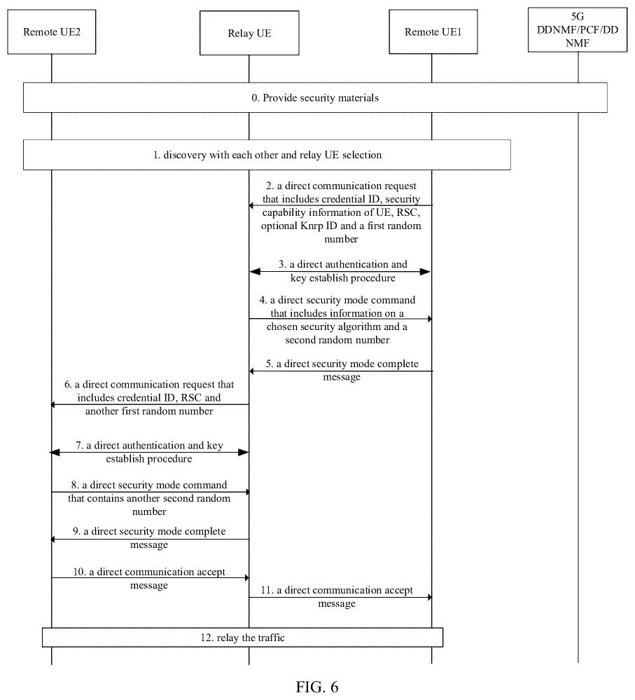

Referring to FIG. 6, an example of the present disclosure provides an information processing method, which may include the following steps.
0. Security materials need to be provided to remote UEs and a U2U relay, i.e., the aforementioned relay UE, before a U2U device discovery and link establishment procedure. In this step, long term credential and long term credential ID may also be provided to the UEs by the network if no long term credential is pre-positioned in the UEs and the U2U relay.
1. A discovery and relay selection procedure is performed between the remote UEs and the UE-to-UE relay using the discovery parameters and the discovery security material.

It is worth noting: assuming that the remote UE1 and the remote UE2 discovered and selected the same U2U relay (i.e., the relay UE), both the remote UE1 and the remote UE2 need to establish secure PC5 communications with the U2U relay respectively.
2. The remote UE1 sends a direct communication request that contains the long term credential ID, security capabilities of the remote UE1, and RSC of a 5G ProSe U2U Relay service or ProSe code. When the remote UE1 sends the direct communication request attempting to communicate with the U2U relay, the direct communication request may also include an NR PC5 key (Knrp) ID. The Knrp ID is an intermediate key ID. This Knrp is the intermediate key.
3. The U2U relay may initiate a direct authentication and key establish procedure with the remote UE1 to generate the Knrp. If the Knrp ID is included in the direct communication request and the Knrp corresponding to the Knrp ID is still valid, this step is skipped.
4. The U2U relay shall obtain the session key (K_{NRP-sess}) from the Knrp and then obtain a confidentiality protection key (NR PC5 encryption key, NRPEK) and an integrity protection key (NR PC5 integrity key, NRPIK) based on PC5 security policies. The U2U relay sends a direct security mode command to the remote UE1. The direct security mode command shall include a chosen security algorithm and a second random number (i.e., nonce 2).
5. If the direct security mode command passes an integrity check, the remote UE1 sends a direct security mode complete message to the U2U relay.
6. The U2U relay sends a direct communication request that contains the long term credential ID, security capabilities of the relay UE, the RSC of the 5G ProSe U2U relay service or the ProSe code, and a first random number (i.e., nonce 1) to the remote UE2. The message may also include a Knrp ID. If the U2U relay has an existing Knrp with the remote UE2 and the Knrp is still valid, the Knrp may continue to be used.
7. The remote UE2 may initiate a direct authentication and key establish procedure with the U2U relay to generate Knrp′. If the Knrp ID′ is included in the direct communication request and the Knrp′ corresponding to the Knrp ID′ is still valid, this step is skipped.
8. The remote UE2 shall derive a session key (K_{NRP-sess′}) from the K_{NRP′} and then derive the confidentiality protection key (NRPEK′) if applicable and the integrity protection key (NRPIK′) based on the PC5 security policies. The remote UE2 sends a direct security mode command to the U2U relay. The direct security mode command shall include algorithm information on the chosen security algorithm and a second random number (nonce 2).
9. The U2U relay responds with a direct security mode complete message to the remote UE2.
10. Once receiving the direct security mode complete message from the U2U relay, the remote UE 2 sends a direct communication accept message to the U2U relay.
11. After receiving the direct communication accept message, the U2U relay sends a direct communication accept message to the remote UE1.
12. A secure L3 PC5 link between the remote UE1 and the remote UE2 via the U2U relay is established. The U2U relay can relay the traffic between the peer UEs.

As illustrated in FIG. 7, an example of the present disclosure provides an information processing apparatus 100, and the apparatus 100 includes:

a first acquiring module 110 that is configured to acquire a credential, where the credential includes a first key; and

a first communicating module 120 that is configured to carry out a secure direct communication with a second UE based on the first key.

The information processing apparatus 100 may be a component of the first UE.

In some examples, the first acquiring module 110 may correspond to one or more processors. The one or more processors include, but are not limited to, one or more central processing units (CPUs). The one or more processors may further be other general-purpose processors, digital signal processors (DSPs), application specific integrated circuits (ASICs), field programmable gate arrays (FPGAs) or another programmable logic devices, transistor logic devices, hardware components, or any combination thereof. The general-purpose processor may include a microprocessor or any conventional processor.

The first communicating module 120 may correspond to one or more transceivers or one or more transceiver antennas, etc.

In some examples, the first communicating module 120 is configured to send a direct communication request to the second UE. The direct communication request includes a credential ID.

A first negotiating module is configured to negotiate a session key with the second UE according to an intermediate key corresponding to the credential ID. The intermediate key is generated based on the first key.

A first generating module is configured to generate a second key for the secure direct communication based on the session key.

In some examples, the direct communication request further includes at least one of the following:

security capability information of the first UE, configured for negotiating with the second UE a security algorithm for carrying out the secure direct communication;

RSC;

ProSe code;

a first random number, configured for generating the session key; or

an intermediate key ID, where the intermediate key is generated based on the first key.

In some examples, the apparatus further includes:

a first determining module that is configured to determine whether it is not a first time that the first UE and the second UE carry out the secure direct communication; and

a second negotiating module that is configured to negotiate the intermediate key based on the first key in response to the first time that the first UE and the second UE carry out the secure direct communication.

In some examples, the apparatus further includes:

a second acquiring module that is configured to acquire the intermediate key that is generated based on the first key in a historical secure direct communication between the first UE and the second UE and is still within a valid period in response to determining that it is not the first time that the first UE and the second UE carry out the secure direct communication.

In some examples, the first communicating module 120 is further configured to receive a direct security mode command that includes a second random number.

A second generating module is configured to generate the session key according to the first random number and the second random number.

A third generating module is configured to generate the second key based on the session key.

A checking module is configured to perform an integrity check on the direct security mode command with the second key.

The first communicating module 120 is further configured to send a direct security mode complete message to the second UE in response to determining that the direct security mode command passes the integrity check.

In some examples, the direct security mode command further includes algorithm information on a security algorithm. The security algorithm is selected by the second UE according to the security capability information of the first UE.

In some examples, the first UE is the relay UE, and the second UE includes a source UE and/or a target UE of the secure direct communication. The apparatus further includes:

a first establishing module that is configured to establish the secure direct communication between the source UE and the target UE after the relay UE generates the second keys with the source UE and the target UE respectively.

In some examples, the first establishing module is configured to send a direct communication accept message to the source UE after determining that each of the source UE and the target UE generates the second key.

The first communicating module 120 is further configured to establish the secure direct communication between the source UE and the target UE with sending the direct communication accept message to the source UE.

In some examples, the first communication module 120 is further configured to request the credential from a network device.

In some examples, the credential is pre-positioned in the first UE.

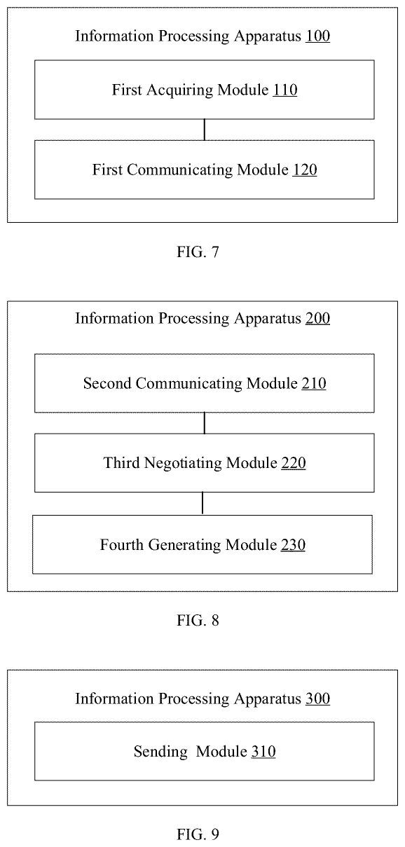

As illustrated in FIG. 8, an example of the present disclosure provides an information processing apparatus 200, and the apparatus 200 includes:

a second communicating module 210 that is configured to receive a direct communication request sent by a first UE, where the direct communication request includes a credential ID, and the first UE is a U2U relay UE or a remote UE;

a third negotiating module 220 that is configured to negotiate a session key with the first UE according to an intermediate key corresponding to the credential ID, where the intermediate key is generated based on a first key; and

a fourth generating module 230 that is configured to generate a second key for a secure direct communication with the first UE based on the session key.

In some examples, the information processing apparatus 200 may be included in a second UE.

The second communicating module 210 may correspond to one or more transceivers.

The third negotiating module 220 and the fourth generating module 230 may both correspond to one or more processors.

In some examples, the direct communication request further includes at least one of the following:

security capability information of the first UE, configured for negotiating with the second UE a security algorithm for carrying out the secure direct communication;

RSC;

ProSe code;

a first random number, configured for generating the session key; or

an intermediate key ID, where the intermediate key is generated based on the first key.

In some examples, the apparatus further includes:

a second determining module that is configured to determine the intermediate key according to the intermediate key ID if the direct communication request includes the intermediate key ID;

or

a fifth generating module that is configured to generate the intermediate key based on the first key if the direct communication request includes no intermediate key ID.

In some examples, the second communicating module 210 is further configured to send a direct security mode command that includes a second random number.

The apparatus further includes:

a sixth generating module that is configured to generate the session key according to the first random number and the second random number; and

a seventh generating module that is configured to generate the second key based on the session key.

The second communicating module 210 is further configured to receive a direct security mode complete message sent by the first UE. The direct security complete message is sent after the direct security mode command passes an integrity check based on a second key generated by the first UE.

In some examples, the direct security mode command further includes algorithm information on a security algorithm. The security algorithm is selected by the second UE according to the security capability information of the first UE.

As illustrated in FIG. 9, an example of the present disclosure provides an information processing apparatus 300, and the apparatus 300 includes:

a sending module 310 that is configured to send a stored credential to a first UE, where the first UE includes a relay UE and/or a remote UE, and the relay UE is configured for U2U relay communications.

The credential includes a first key, and the first key is configured for a secure direct communication between the first UE and a second UE. The second UE is a peer UE of the first UE.

The information processing apparatus 300 may be included in a network device.

The sending module 310 may correspond to one or more transceivers.

The information processing apparatus may further include a storing module, which may be configured to store the credential.

The present disclosure provides a communication device, including:

one or more memories for storing instructions executable by one or more processors; and

the one or more processors connected to the one or more memory individually.

The one or more processors are configured to perform the information processing method provided by any of the aforementioned technical solutions.

The one or more memories may include a storage medium of various types. The storage medium is a non-transitory computer storage medium that is capable of keeping information thereon stored after the communication device is powered off.

The communication device includes the UE or the network device.

The one or more processors may be connected to the one or more memories through a bus or the like, and are configured to read an executable program stored on the one or more memories, for example, at least one of the methods illustrated in FIG. 2, FIGS. 3A to 3C, and FIG. 4 to FIG. 6.

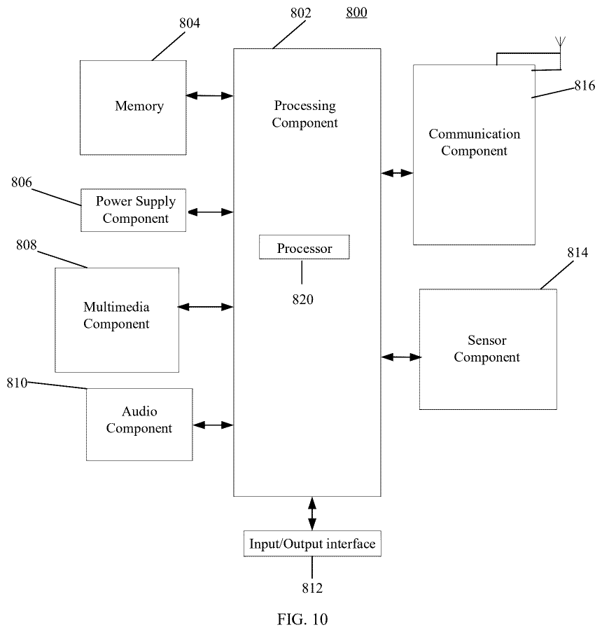

FIG. 10 illustrates a block diagram of a UE 800 according to an example. For example, the UE 800 may be a mobile phone, a computer, a digital broadcasting user device, a messaging device, a game console, a tablet device, a medical device, a fitness device, a personal digital assistant, and the like.

Referring to FIG. 10, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the UE 800, such as operations associated with display, phone calls, data communications, camera operations, and recording operations. The processing component 802 may include one or more processors 820 to execute instructions to generate all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operations of the UE 800. Examples of such data include instructions for any application or method operated on the UE 800, contact data, phonebook data, messages, pictures, videos, and the like. The memory 804 may be implemented by any type of volatile or non-volatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic or Optical Disk.

The power supply component 806 provides power for various components of the UE 800. The power supply component 806 may include a power management system, one or more power supplies, and other components associated with generating, managing, and distributing power for the UE 800.

The multimedia component 808 includes a screen providing an output interface between the UE 800 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 808 includes a front camera and/or a rear camera. The front camera and/or rear camera may receive external multimedia data when the UE 800 is in an operating mode, such as a photographing mode or a video mode. Each of the front and rear cameras can be a fixed optical lens system or have focal length and optical zoom capability.

The audio component 810 is configured to output and/or input an audio signal. For example, the audio component 810 includes a microphone (MIC) that is configured to receive an external audio signal when the UE 800 is in an operating mode, such as a call mode, a recording mode, and a voice recognition mode. The received audio signal may be further stored in memory 804 or transmitted via communication component 816. In some examples, the audio component 810 also includes a speaker for outputting an audio signal.

The I/O interface 812 provides an interface between the processing component 802 and a peripheral interface module. The above peripheral interface module may be a keyboard, a click wheel, buttons, or the like. These buttons may include but not limited to a home button, a volume button, a start button and a lock button.

The sensor component 814 includes one or more sensors to provide the UE 800 with status assessments in various aspects. For example, the sensor component 814 may detect an open/closed state of the UE 800 and a relative positioning of components such as the display and keypad of UE 800, and the sensor component 814 may also detect a change in position of UE 800 or a component of UE 800, the presence or absence of the target object contacting with UE 800, orientation or acceleration/deceleration of UE 800, and temperature change of UE 800. The sensor component 814 may include a proximity sensor configured to detect the presence of a nearby object without any physical contact. The sensor component 814 may also include a light sensor, such as a complementary metal oxide semiconductor (CMOS) or charge-coupled device (CCD) image sensor, for being applied in imaging applications. In some examples, the sensor component 814 may also include an acceleration sensor, a gyro sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G, 3G, 4G, 5G, 6G or a combination thereof. In an example, the communication component 816 receives broadcast signals or broadcast related information from an external broadcast management system via a broadcast channel. In an example, the communication component 816 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the UE 800 may be implemented by one or more application specific integrated circuits (ASIC), digital signal processors (DSP), digital signal processing equipment (DSPD), programmable logic devices (PLD), field programmable gate array (FPGA), controller, microcontroller, microprocessor, or other electronics to perform the aforementioned methods.

In one or more examples, there is also provided a non-transitory computer-readable storage medium including instructions, such as the memory 804 including instructions. These instructions may be executed by the one or more processors 820 of the UE 800 to generate the aforementioned methods. For example, the non-transitory computer-readable storage medium may be ROM, random access memory (RAM), CD-ROM, magnetic tape, floppy disk, optical data storage device, and the like.

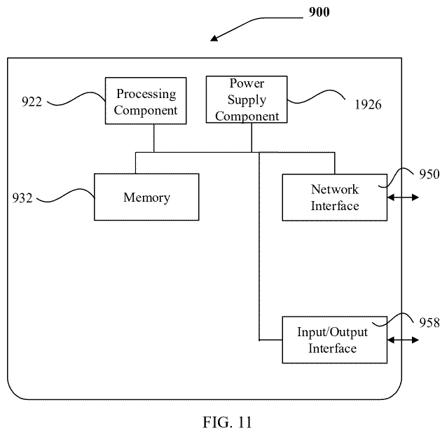

As illustrated in FIG. 11, an example of the present disclosure illustrates a structure of a network device. For example, the network device 900 may be provided as a network-side device, such as a network device of a core network.

Referring to FIG. 11, the network device 900 includes a processing component 922 which further includes one or more processors, and a memory resource represented by a memory 932 which is used to store instructions that may be executed by the processing component 922, such as application programs. The application programs stored in the memory 932 may include one or more modules, each of which corresponds to a set of instructions. In addition, the processing component 922 is configured to execute instructions to perform any of the forgoing methods applied to the access device, for example, as illustrated in FIG. 2, FIGS. 3A to 3C, and FIG. 4 to FIG. 6.

The network device 900 may also include a power supply component 926 which is configured to perform power management for the network device 900, a wired or wireless network interface 950 which is configured to connect the network device 900 to a network, and an input/output (I/O) interface 958. The network device 900 may performs operations by adopting an operating system stored in memory 932, such as Windows Server™, Mac OS X™, Unix™, Linux™, FreeBSD™, or the like.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It should be understood that the present disclosure is not limited to the above described accurate structures illustrated in the drawings, and various modifications and changes can be made to the present disclosure without departing from the scope thereof. The scope of the present disclosure is to be limited only by the appended claims.

1. A method for information processing performed by a first user equipment (UE) that is a UE-to-UE (U2U) relay UE or a remote UE, the method comprising:
acquiring a credential, wherein the credential comprises a first key; and
carrying out a secure direct communication with a second UE based on the first key.

2. The method according to claim 1, wherein carrying out the secure direct communication with the second UE based on the first key comprises:
sending a direct communication request to the second UE, wherein the direct communication request comprises a credential identity (ID);
negotiating a session key with the second UE according to an intermediate key corresponding to the credential ID, wherein the intermediate key is generated based on the first key; and
generating a second key for the secure direct communication based on the session key.

3. The method according to claim 2, wherein the direct communication request further comprises at least one of:
security capability information of the first UE, configured for negotiating with the second UE a security algorithm for carrying out the secure direct communication;
relay service code (RSC);
proximity-based service (ProSe) code;
a first random number, configured for generating the session key; or
an intermediate key ID, wherein the intermediate key is generated based on the first key.

4. The method according to claim 2, further comprising:
determining whether it is not a first time that the first UE and the second UE carry out the secure direct communication; and
negotiating the intermediate key based on the first key, wherein it is the first time that the first UE and the second UE carry out the secure direct communication.

5. The method according to claim 4, further comprising:
acquiring the intermediate key that is generated based on the first key in a historical secure direct communication between the first UE and the second UE and is still within a valid period, wherein it is not the first time that the first UE and the second UE carry out the secure direct communication.

6. The method according to claim 3, further comprising:
receiving a direct security mode command that comprises a second random number;
generating the session key according to the first random number and the second random number;
generating the second key based on the session key;
performing an integrity check on the direct security mode command with the second key; and
sending a direct security mode complete message to the second UE, wherein the direct security mode command passes the integrity check.

7. The method according to claim 6, wherein the direct security mode command further comprises algorithm information on the security algorithm, wherein the security algorithm is selected by the second UE according to the security capability information of the first UE.

8. The method according to claim 2, wherein the first UE is the relay UE, and the second UE comprises at least one of a source UE or a target UE of the secure direct communication; and
wherein the method further comprises:
establishing the secure direct communication between the source UE and the target UE after the relay UE generates the second keys with the source UE and the target UE respectively.

9. The method according to claim 8, wherein establishing the secure direct communication between the source UE and the target UE after the relay UE generates the second keys with the source UE and the target UE respectively comprises:
sending a direct communication accept message to the source UE after determining that each of the source UE and the target UE generates the second key; and
establishing the secure direct communication between the source UE and the target UE after sending the direct communication accept message to the source UE.

10. The method according to claim 1, further comprising:
requesting the credential from a network device.

11. The method according to claim 1, wherein the credential is pre-positioned in the first UE.

12. A method for information processing performed by a second user equipment (UE), the method comprising:
receiving a direct communication request sent by a first UE, wherein the direct communication request comprises a credential identity (ID), and the first UE is a UE-to-UE (U2U) relay UE or a remote UE;
negotiating a session key with the first UE according to an intermediate key corresponding to the credential ID, wherein the intermediate key is generated based on a first key; and
generating, based on the session key, a second key for a secure direct communication with the first UE.

13. The method according to claim 12, wherein the direct communication request further comprises at least one of:
security capability information of the first UE, configured for negotiating with the second UE a security algorithm for carrying out the secure direct communication;
relay service code (RSC);
proximity-based service (ProSe) code;
a first random number, configured for generating the session key; or
an intermediate key ID, wherein the intermediate key is generated based on the first key.

14. The method according to claim 13, further comprising:
determining the intermediate key according to the intermediate key ID, wherein the direct communication request comprises the intermediate key ID and the intermediate key corresponding to the intermediate key ID is within a valid period; and
generating the intermediate key based on the first key, wherein the direct communication request comprises no intermediate key ID.

15. The method according to claim 13, further comprising:
sending a direct security mode command that comprises a second random number;
generating the session key according to the first random number and the second random number;
generating the second key based on the session key; and
receiving a direct security mode complete message sent by the first UE, wherein the direct security mode complete message is sent after the direct security mode command passes an integrity check based on a second key generated by the first UE.

16. The method according to claim 15, wherein the direct security mode command further comprises algorithm information on the security algorithm, wherein the security algorithm is selected by the second UE according to the security capability information of the first UE.

17. A method for information processing performed by a network device, the method comprising:
sending a stored credential to a first user equipment (UE),
wherein the first UE comprises a relay UE and/or a remote UE, and the relay UE is configured for UE-to-UE (U2U) relay communications,
wherein the stored credential comprises a first key, and the first key is configured for a secure direct communication between the first UE and a second UE, and
wherein the second UE is a peer UE of the first UE.

18.-20. (Cancelled)

21. A communication device, comprising:
one or more processors,
one or more transceivers,
one or more memories, and
an executable program stored on the one or more memories,
wherein the executable program when collectively executed by the one or more processors cause the communication device to act as the first UE and perform the method according to claim 1.

22. (canceled)

23. A communication device, comprising:
one or more processors,
one or more transceivers,
one or more memories, and
an executable program stored on the one or more memories,
wherein the executable program when collectively executed by the one or more processors causes the communication device to as the second UE and perform the method according to claim 12.

24. A communication device, comprising:
one or more processors,
one or more transceivers,
one or more memories, and
an executable program stored on the one or more memories and capable of being run by the one or more processors,
wherein the executable program when collectively executed by the one or more processors cause the communication device to act as the network device and perform the method according to claim 17.
